(19) United States
(12) Patent Application Publication
(10) Pub. No.: US 2021/0267209 A1
(43) Pub. Date: Sep. 2, 2021

(54) METHODS OF CONTROLLING RICE WATER WEEVIL

(71) Applicant: Valent U.S.A. LLC, Walnut Creek, CA (US)

(72) Inventors: Mallory Everett, McCory, AR (US); Frank Carey, Olive Branch, MS (US)

(21) Appl. No.: 16/803,608

(22) Filed: Feb. 27, 2020

(51) Int. Cl. A01N 57/28; A01N 43/78; A01N 43/40; A01N 43/88; A01N 43/08; A01N 33/08

(52) U.S. Cl. CPC A01N 57/28; A01N 43/78; A01N 33/08; A01N 43/88; A01N 43/08; A01N 43/40

(57) ABSTRACT

The present invention is directed to a method of controlling Lissorhoptrus oryzophilus (“L. oryzophilus”) comprising applying an effective amount of a mixture of one or more neonicotinoids, urea and optionally, 3 N-(n-butyl)-thiophosphoric triamide to the L. oryzophilus or an area in need of L. oryzophilus control. The present invention is further directed to a method of controlling L. oryzophilus comprising mixing a first composition comprising one or more neonicotinoids and and optionally, 3 N-(n-butyl)-thiophosphoric triamide with a second composition containing urea to create a tank mix and applying the tank mix to the L. oryzophilus or an area in need of L. oryzophilus control.

### FIELD OF THE INVENTION

The present invention is directed to a method of controlling Lissorhoptrus oryzophilus (“L. oryzophilus”) comprising applying an effective amount of a mixture of one or more neonicotinoids, urea and optionally, 3 N-(n-butyl)-thiophosphoric triamide to the L. oryzophilus or an area in need of L. oryzophilus control. The present invention is further directed to a method of controlling L. oryzophilus comprising mixing a first composition comprising one or more neonicotinoids and optionally, 3 N-(n-butyl)-thiophosphoric triamide with a second composition containing urea to create a tank mix and applying the tank mix to the L. oryzophilus or an area in need of L. oryzophilus control.

### BACKGROUND OF THE INVENTION

Rice water weevil (Lissorhoptrus oryzophilus) is a pest of rice plants. The rice water weevil is one of the most economically damaging pest to rice crops in the United States. Although the rice water weevil is indigenous to the United States, it has been found in rice crops throughout the world.

Neonicotinoids have been demonstrated as an effective control of the rice water weevil. However, application of the neonicotinoid can be costly. Further, the amount of neonicotinoid that must be applied can sometimes be cost prohibitive to other methods such as delayed flooding and planting. However, flooding and planting during standard times lead to greater grain yields over delayed timing.

Thus, there is a need in the art for a method of controlling rice water weevils with neonicotinoids that is cost-effective and allows for standard planting and flooding practices.

### SUMMARY OF THE INVENTION

In one embodiment, the present invention is directed to a method of controlling Lissorhoptrus oryzophilus (“L. oryzophilus”) comprising applying an effective amount of a mixture of one or more neonicotinoids, urea and optionally, 3 N-(n-butyl)-thiophosphoric triamide to the L. oryzophilus or an area in need of L. oryzophilus control.

In another embodiment, the present invention is further directed to a method of controlling L. oryzophilus comprising mixing a first composition comprising one or more neonicotinoids and optionally, 3 N-(n-butyl)-thiophosphoric triamide with a second composition containing urea to create a tank mix and applying the tank mix to the L. oryzophilus or an area in need of L. oryzophilus control.

### DETAILED DESCRIPTION OF THE INVENTION

It was surprisingly discovered that the addition of a neonicotinoid to a urea-based fertilizer improved the control of Lissorhoptrus oryzophilus (“L. oryzophilus”) over the neonicotinoid alone.

In one embodiment, the present invention is directed to a method of controlling Lissorhoptrus oryzophilus (“L. oryzophilus”) comprising applying an effective amount of a mixture of one or more neonicotinoids, urea and optionally, 3 N-(n-butyl)-thiophosphoric triamide (“NBPT”) to the L. oryzophilus or an area in need of L. oryzophilus control.

In another embodiment, the present invention is further directed to a method of controlling L. oryzophilus comprising mixing a first composition comprising one or more neonicotinoids and optionally, NBPT with a second composition containing urea to create a tank mix and applying the tank mix to the L. oryzophilus or an area in need of L. oryzophilus control.

In a preferred embodiment, the effective amount of urea is from about 1 to about 1,000 kilograms per hectare, more preferably from about 10 to about 700 kilograms per hectare and even more preferably from about 150 to about 350 kilograms per hectare.

In a preferred embodiment, the effective amount of one or more neonicotinoids is from about 1 to about 1,000 grams per hectare, more preferably from about 10 to about 700 grams per hectare and even more preferably from about 100 to about 500 grams per hectare and even more preferably about 280 grams per acre.

In another preferred embodiment, the weight ratio of the one or more neonicotinoids to urea is from about 1:10 to about 1:10,000, more preferably from about 1:100 to about 1:2,000 and even more preferably from about 1:600 to about 1:1,200.

In a preferred embodiment, the at least one neonicotinoid is selected from the group consisting of clothianidin, acetamiprid, imidacloprid, thiamethoxam, dinotefuran, nitenpyram, and thiacloprid. In a more preferred embodiment, the neonicotinoid is clothianidin.

In another preferred embodiment, the composition containing urea is a fertilizer.

In a preferred embodiment, the L. oryzophilus are larvae.

The mixtures or tank mixes of the present invention may be applied to any area in need of L. oryzophilus control. Areas in need of L. oryzophilus control include, but are not limited to, rice plants, areas where rice will be planted including fields and areas where rice has been planted including fields.

The mixtures and compositions of the present invention can be applied by any convenient means. Those skilled in the art are familiar with the modes of application that include foliar applications such as spraying, chemigation (a process of applying the composition through the irrigation system), by granular application, or by impregnating the composition on fertilizer.

The compositions of the present invention can be prepared as concentrate formulations or as ready-to-use formulations. The compositions can be tank mixed.

Throughout the application, the singular forms “a,” “an,” and “the” include plural reference unless the context clearly dictates otherwise.

As used herein, all numerical values relating to amounts, weight percentages and the like are defined as “about” or “approximately” each particular value, plus or minus 10%. For example, the phrase “at least 5.0% by weight” is to be understood as “at least 4.5% to 5.5% by weight.” Therefore, amounts within 10% of the claimed values are encompassed by the scope of the claims.

3 N-(n-butyl)-thiophosphoric triamide (“NBPT”; CAS #94317-64-3) is commercially available in Agrotain®. Agrotain® is available from and a registered trademark of Koch Agronomic Services.

These representative embodiments are in no way limiting and are described solely to illustrate some aspects of the invention.

Further, the following example is offered by way of illustration only and not by way of limitation.

### EXAMPLE

Belay® is used as the source of 23% clothianidin and is available from and a registered trademark of Valent U.S.A., LLC.

NipsIt Inside® is used as the source of 47.8% clothianidin and is available from and a registered trademark of Valent U.S.A., LLC.

Karate® Z is used as the source of 22.8% lambda-cyhalothrin and is available from and a registered trademark of Syngenta.

### Control of Rice Water Weevil Larvae

### Method

6 plots of rice were planted in a field and flooded to complete growing cycle. 4 plots were treated prior to flooding with 23% clothianidin (Belay®), 47.8% clothianidin (NipsIt Inside®), 22.8% lambda-cyhalothrin or 23% clothianidin impregnated urea. 1 plot was treated post flooding with 23% clothianidin. Results can be found in Table 1, below. All data was analyzed for significance.

TABLE 1

| | | |
|---|---|---|
| | Average Rice Water | |
| | Weevil Larvae per | % Reduction |
| Treatment | Soil Core Sample | from Control |

Pre-Flood Application

| | | |
|---|---|---|
| Untreated Control | 13.08 a | n/a |
| 47.8% Clothianidin | 10.4 ab | 25% |
| 22.8% Lambda- | 10.16 ab | 22% |
| cyhalothrin | | |
| 23% Clothianidin | 10.16 ab | 22% |
| 23% Clothianidin | 6.8 b | 48% |
| impregnated Urea | | |

Post-Flood Application

| | | |
|---|---|---|
| 23% Clothianidin | 12.3 ab | 6% |

### Results

As seen in Table 1, above, application of clothianidin impregnated urea was twice as effective at controlling rice water weevil (Lissorhoptrus oryzophilus) larvae as clothianidin application alone.

What is claimed is:

1. A method of controlling Lissorhoptrus oryzophilus (L. oryzophilus) comprising applying a mixture of an effective amount of one or more neonicotinoids and an effective amount of urea to the L. oryzophilus or an area in need of L. oryzophilus control.

2. The method of claim 1, wherein the effective amount of one or more neonicotinoids is from about 1 to about 1,000 grams per hectare.

3. The method of claim 1, wherein the effective amount of one or more neonicotinoids is from about 10 to about 700 grams per hectare.

4. The method of claim 1, wherein the effective amount of urea is from about 1 to about 1,000 kilograms per hectare.

5. The method of claim 1, wherein the effective amount of urea is from about 10 to about 700 kilograms per hectare.

6. The method of claim 1, wherein the weight ratio of one or more neonicotinoids to urea is from about 1:10 to about 1:10,000.

7. The method of claim 1, wherein the weight ratio of one or more neonicotinoids to urea is from about 1:100 to about 1:2,000.

8. The method of claim 1, wherein the weight ratio of one or more neonicotinoids to urea is from about 1:600 to about 1:1,200.

9. The method of claim 1, wherein the one or more neonicotinoids is selected from the group consisting of clothianidin, acetamiprid, imidacloprid, thiamethoxam, dinotefuran, nitenpyram, and thiacloprid.

10. The method of claim 1, wherein in the one or more neonicotinoids is clothianidin.

11. The method of claim 1, wherein the mixture further comprises 3 N-(n-butyl)-thiophosphoric triamide.

12. The method of claim 1, wherein the mixture is applied to an area in need of L. oryzophilus control.

13. The method of claim 12, wherein the area in need of L. oryzophilus control is a field where rice will be planted.

14. The method of claim 12, wherein the area in need of L. oryzophilus control is a field where rice has been planted.

15. The method of claim 12, wherein the area in need of L. oryzophilus control is a rice plant.

16. The method of claim 1, wherein the L. oryzophilus are larvae.

17. A method of controlling Lissorhoptrus oryzophilus (L. oryzophilus) comprising:
a. mixing a first composition comprising one or more neonicotinoids with a second composition containing urea to create a tank mix; and
b. applying the tank mix to the L. oryzophilus or an area in need of L. oryzophilus control.

18. The method of claim 17, wherein the one or more neonicotinoids is selected from the group consisting of clothianidin, acetamiprid, imidacloprid, thiamethoxam, dinotefuran, nitenpyram, and thiacloprid.

19. The method of claim 17, wherein in the one or more neonicotinoids is clothianidin.

20. The method of claim 17, wherein the first composition further comprises 3 N-(n-butyl)-thiophosphoric triamide.

21. The method of claim 17, wherein the L. oryzophilus are larvae.
